(19) United States
(12) Patent Application Publication
(10) Pub. No.: US 2003/0053897 A1
(43) Pub. Date: Mar. 20, 2003

(54) Lifting platform, particularly mobile lifting platform

(76) Inventor: Gerhard Finkbeiner, Freudenstadt (DE)

Correspondence Address: M. Robert Kestenbaum, 11011 Bermuda Dunes NE, Albuquerque, NM, 87111, US

(21) Appl. No.: 10/213,023

(22) Filed: Aug. 4, 2002

(30) Foreign Application Priority Data
Aug. 22, 2001 (DE) 101 40 238.4

(51) Int. Cl. B62B 1/06

(52) U.S. Cl. 414/453

(57) ABSTRACT

A lifting platform, particularly a mobile lifting platform, for lifting loads, vehicles, or the like, has a base frame, a lifting unit that moves a load receiver up and down, and at least one supply line that is provided between at least two lifting platforms. At least one receiving device is installed for receiving the at least one supply line and positioning the at least one supply line that runs between two lifting platforms, outside the working region of the lifting platform.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to a lifting platform, and in particular for a mobile lifting platform for lifting loads, vehicles, and the like.

### TECHNICAL FIELD

In lifting technology, particularly for commercial vehicles, individual lifting platforms are used in order to lift the commercial vehicle for repair and maintenance purposes. The lifting platforms have load-receiver that are placed on the wheels, for example. For a three-axle vehicle, six lifting platforms are for example positioned to the respective wheels. In addition to this, the individual mobile lifting platforms are connected together by at least one supply line. These supply lines include current leads and/or control leads. In many cases, the supply lines can also be constituted as hydraulic or pneumatic hoses. The supply lines are laid from a central supply station to a first lifting platform. From there, a supply line is connected to the second lifting platform. The supply lines are thus run from lifting platform to lifting platform, until each lifting platform is connected to a supply line. For maintenance and repair of the vehicle, it is required that a workshop car or gearbox lifter or the like be positioned in the working space or working region beneath the vehicle. Accessibility is made difficult by the supply line lying on the floor, or there is a risk of damaging the supply line on traveling over it. Moreover there is a risk that the working personnel will trip over the supply lines laying on the floor.

To avoid this danger, it was long ago proposed to mount the supply lines on a workshop ceiling. The line ends hang down from the ceiling and can be connected to the individual lifting platforms. This embodiment has the disadvantage, however, that the working region for positioning the lifting platform is determined by the supply lines hanging from the ceiling. Furthermore, the mounting of the supply lines on the ceiling is expensive and cost-intensive. When the lifting platforms are used in the open, the supply lines again lie on the ground.

### SUMMARY OF THE INVENTION

The object of the invention is to provide a device by means of which the at least one supply line between two lifting platforms is removed from the floor in the working region, so that unhindered and safe working beneath a lifted load or a vehicle is made possible. This object is attained a lifting platform having a working region, for lifting loads, vehicles, or the like, having a base frame, a load receiver, a lifting unit that moves the load receiver up and down, and at least one supply line between at least two lifting platforms. At least one receiving device the receives the at least one supply positions the at least one supply line outside the working region of the lifting platform.

By means of the device according to the invention, which can be fixed onto the lifting platform, the at least one supply line is lifted from the floor during an upward movement of the load receiver, so that the working region is freely accessible in an upper lifting position of the load receiver, without any hindrance from the at least one supply line. An additional drive is not required. The device can advantageously be actuated or moved synchronously with the lifting movement by means of a connection of the device to the load receiver or the lifting column of the lifting platform.

Simple positioning by means of which the supply line can also be arranged outside the lifting region can be given by the advantageous fixing of the device to the load receiver.

According to an advantageous embodiment of the invention, it is provided that the device is rod-shaped and has a cable guide at an upper end. The at least one supply line is thereby positioned in an elevated position with respect to the load receiver, so that the working space is freely accessible. The lifting platforms can also be arranged at a great distance from each other, so that, for example, a length of ten meters between the two lifting platforms is to be bridged over by the at least one supply line. By the cable guiding, elevated with respect to the load receiver, of the at least one supply line by the rod-shaped device, it is ensured that a sufficient passage height is provided beneath the raised supply line, even if there is a slight sag of the supply line in the middle region between the two lifting platforms.

The cable guide arranged at the upper end of the rod-shaped device is preferably constituted as a clamping device. Two functions can thereby be united in one device, thereby again giving a simplified and cost-favorable embodiment.

The cable guide is for example constituted as a V-shaped fork, so that the supply line is fixed automatically by its own weight in the V-shaped fork. This clamping device makes possible a simple insertion of the at least one supply line and thus a quick connection and coupling with the further lifting platforms. This embodiment furthermore has the advantage that clamping is made possible without damage to the outer sheath of the supply line. This embodiment is furthermore suitable for receiving supply lines of different diameters without requiring specific adaptation. This V-shaped fork also makes it possible for the supply line to be clamped under low tension between two spaced-apart equipments, so that sagging of the supply line is reduced, particularly when bridging over great distances.

According to a further embodiment of the invention, at least one further cable guide for the at least one supply line is provided on the load receiver or on the device below the junction point, preferably in the region of the load receiving device. The supply line is additionally guided during the up and down movement of the load receiver, so that the supply line is kept outside the region of movement of the load receiver. Furthermore, release of the at least one supply line from the cable guide constituted as a V-shaped fork is prevented when the load receiver is positioned in a lower position. The section of the supply line arranged between the lifting platforms runs substantially horizontally, and is deflected, for example through 90°, in the clamping connection. The clamping action can thereby be additionally supported. The lower cable guide also ensures that an impermissible tension does not occur and act on the junction point. On connecting up the supply line to the control unit, a minimum length is already established from the upper cable guide over the lower cable guide to the junction point, and is greater than the necessary free length at the maximum lift. At the same time, the supply line can be additionally guided during the lifting movement.

The device is provided releasably in the load receiver. The device according to the invention can thereby be provided as desired, or can be interchanged with other devices adapted for special cases of application. Alternatively, it can also be provided that the device can be fixed to a securing device of the load receiver.

The supply line is connected to a control unit at a junction point. The junction point is provided in a region, which is ergonomically easily accessible for the working personnel. The height of the junction point from the floor corresponds to half of the maximum lifting path. The free path length of the supply line from the junction point in a lower position of the load receiver can thereby be made substantially equal to that in an upper position. Simple geometrical relationships are thereby given which furthermore make a safer operation possible.

The rod-shaped device has a minimum height, which corresponds at least to the ground clearance of vehicles. It is thus made possible that the raised supply lines are not detrimental to the ground clearance.

Furthermore, it can be provided that the rod-shaped device is at least slightly deflectable. It can thereby be made certain that the length of the at least one supply line can be lengthened by the amount of the deflection for a short time, the supply line being yieldable due to a load by a certain amount of path length. At the same time, when connecting the supply line from one to another lifting platform, a prestress is produced between the two devices, so that the amount of sag over the distance to be bridged is reduced.

### BRIEF DESCRIPTION OF THE DRAWINGS

A preferred embodiment of the invention is described in detail in the following description and the accompanying drawings, in which:

FIG. 1 shows a perspective view of a mobile lifting platform with a device according to the invention on a load receiver in a lower position,

FIG. 2 shows a perspective view of the lifting platform according to FIG. 1 in a working position of the load receiver,

FIG. 3 shows a schematic side view of two lifting platforms before a lifting movement to a working height,

FIG. 4 shows a schematic side view of two lifting platforms in a working position,

FIG. 5 shows a schematic diagram of the positioning of lifting platforms and their connection by supply lines,

FIG. 6 shows a schematic diagram of the positioning of lifting platforms with an alternative connection by supply lines, and

FIG. 7 shows a schematic diagram of the positioning of lifting platforms with a further alternative connection by supply lines.

### DETAILED DESCRIPTION OF THE INVENTION

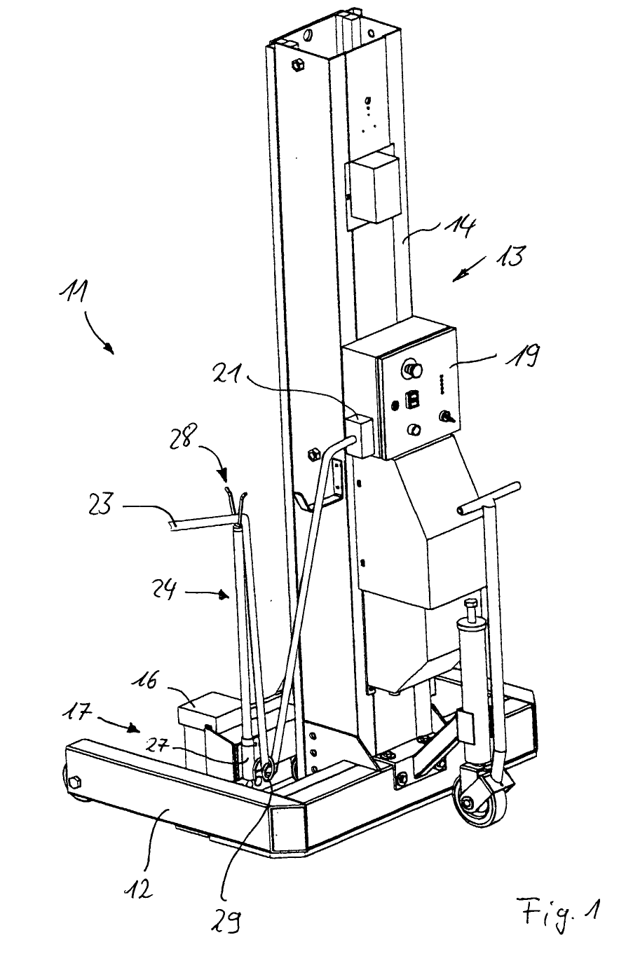

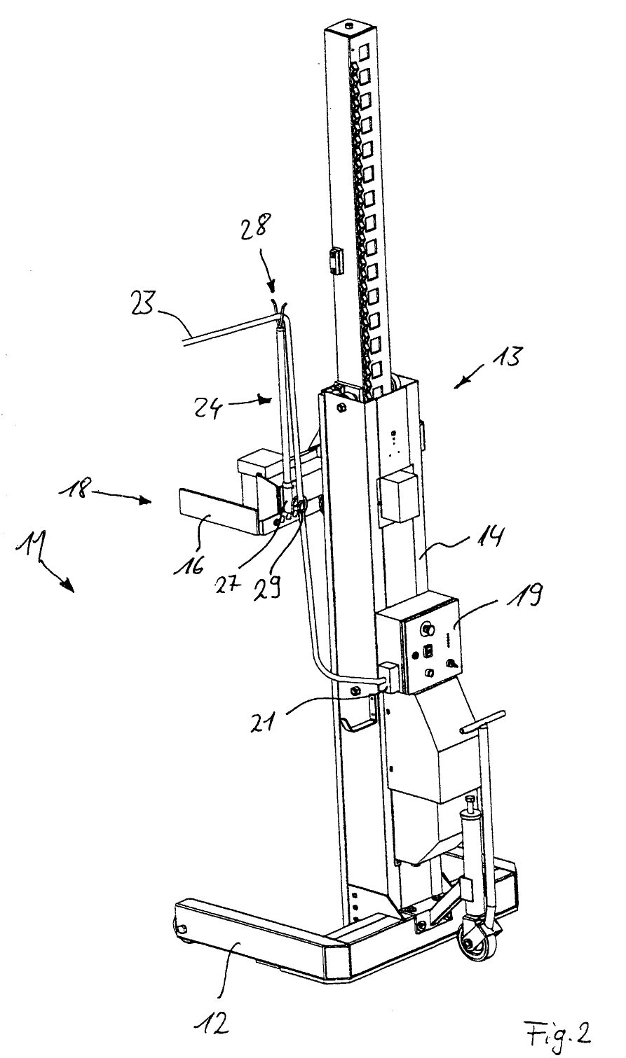

A lifting platform 11 that is suitable for mobile use is shown in FIG. 1. The lifting platform 11 has a base frame 12, preferably with a steer-able traveling means. A lifting unit 13 is provided on the base frame 12, and includes a lifting column 14 in which a drive unit is provided. The drive unit can be electro-hydraulic, hydraulic, or mechanical, for example provided by means of a spindle drive or the like. A load receiver 16 is transferred from an inoperative position 17 into a working position 18 according to FIG. 2 by means of this drive. A control unit 19 is provided on the lifting column 14 and has a junction point 21 at the side.

The load receiver 16 is constituted, for example, as a wheel-gripping element. The mobile lifting platform can thereby be positioned directly at a vehicle to be lifted, with the wheel-gripping element engaging the tire or tires of the vehicle.

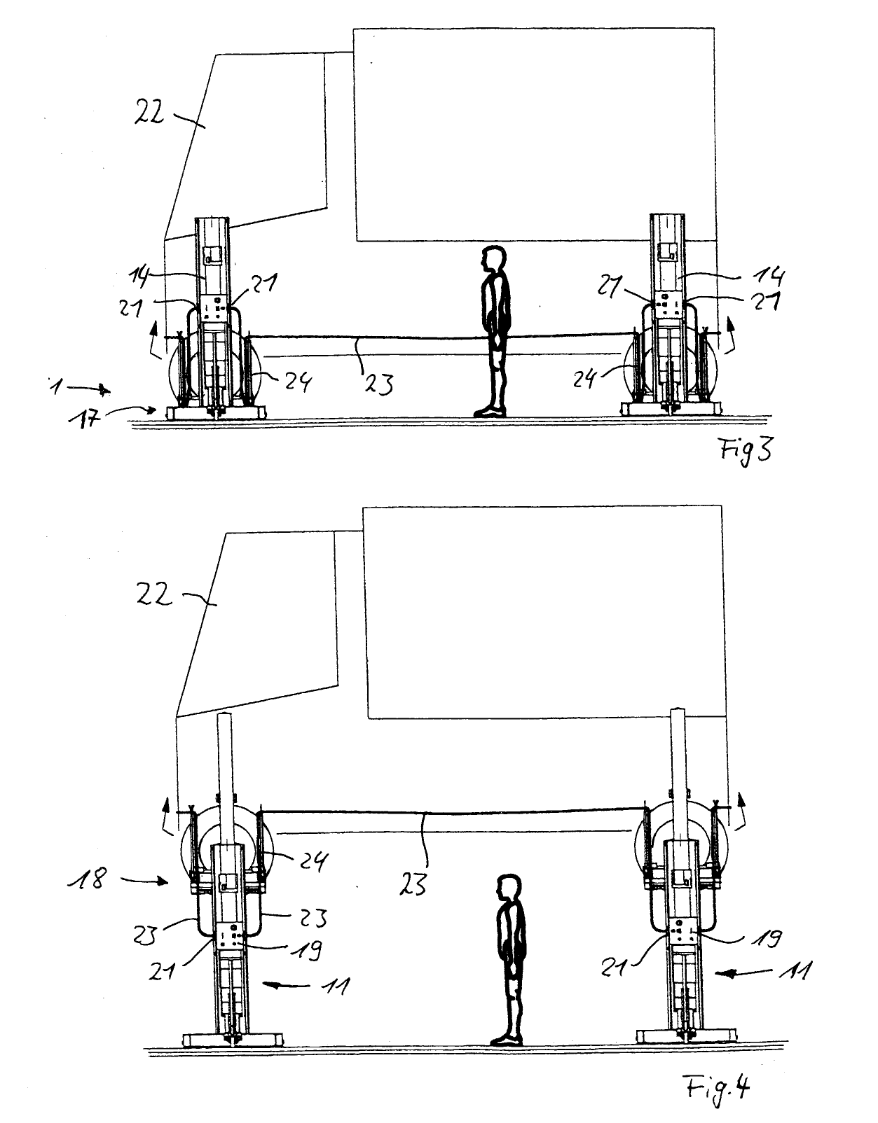

With a two-axle vehicle 22, as shown in FIGS. 3 and 4, for example, two lifting platforms 11 are arranged at each axle. After the lifting platforms 11 are positioned to the vehicle 22, the lifting platforms 11 are connected together by supply lines 23. For example, the supply line 23 serves to supply current, and has control lines.

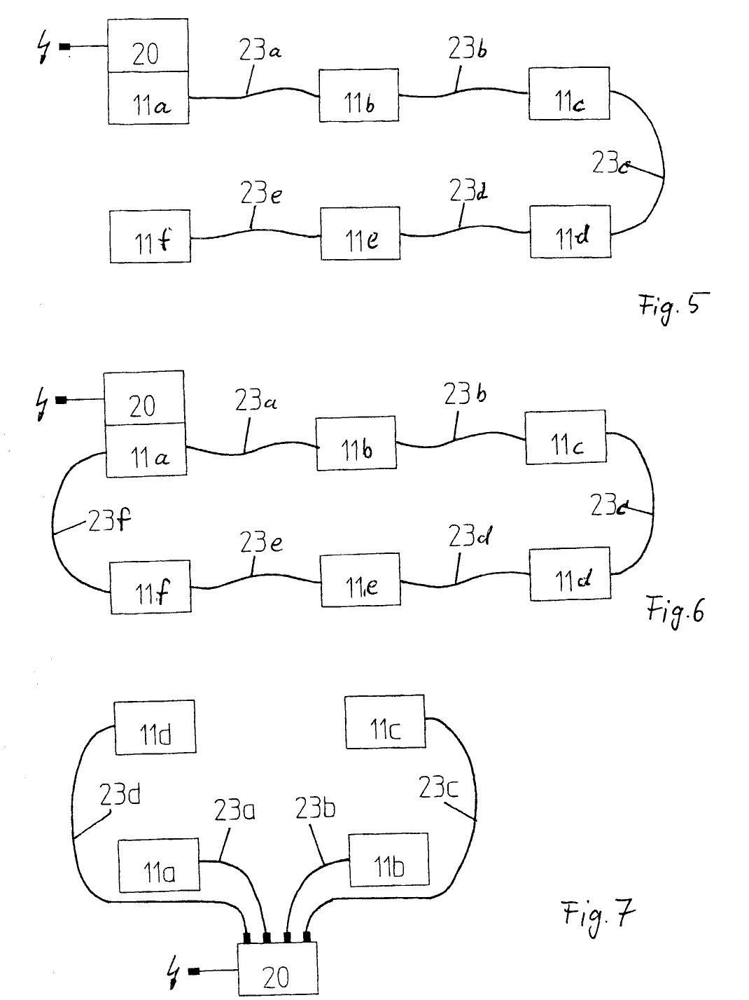

A first possible arrangement and assembly of lifting platforms 11a-11f is shown by way of example in FIG. 5. In this arrangement, the lifting platform 11a is provided, for example, as a principal lifting platform, which has a central control box 20. This can be provided fixed there, for example on the lifting column, or else removable. The basic current supply takes place from an external connection to the central control box 20. This central control box 20 is in its turn connected to the control 19 of the lifting platform 11a.

An open ring connection is shown in FIG. 5, in which the lifting platform 11a is connected via a supply line 23a to the lifting platform 11b. A further control line 23b passes from there to the lifting platform 11c, etc., until the control line 23e is connected to the lifting platform 11f. The control lines are preferably made equal in length. Additionally, two, three, or more supply lines 23, differing in length, can also be used, in order to provide the suitable length for the spaced-apart lifting platforms. The lifting platforms 11a-11f are shown in FIG. 5 for reception of a three-axle vehicle. It will be understood that this arrangement is suitable for two, four, or an optional multiple number of lifting platforms.

An alternative arrangement to FIG. 5 is shown in FIG. 6. In this arrangement, the supply line 23f is additionally provided and forms a closed ring connection. One or other of the connections according to FIGS. 5 or 6 can be used, depending on the control system.

A further alternative control and supply system for the lifting platforms 11a-11d is shown in FIG. 7. For example, four lifting platforms 11a-11d are provided for lifting a two-axle vehicle. The central control 20 is arranged separate from the lifting platforms 11a-11d. A control line 23a runs from the central control 20 to the lifting platform 11a, a control line 23b runs to the lifting platform 11b, and so on. It is advantageously provided that, with such supply lines 23a-23d, which are also termed stub lines, the receiving device 24 raises up the supply lines 23a and 23b when the load receiver 16 is lifted. It is provided that the supply lines 23c and 23d are raised by devices 24 arranged on the lifting platforms 11a and 11b, and also by devices 24 on the lifting platforms 11c and 11d, so that again the whole working region is freely accessible with the exception of the region which is provided between the lifting platforms 11a and 11b for joining the control lines to the central control unit 20.

After each lifting platform 11 is connected to at least one supply line 23, the vehicle 22 can be lifted from the inoperative position 17 into a working position 18 by an actuation of the lifting platforms 11. The working position 18 makes it possible for a person to stand or pass through beneath the vehicle. This whole region, and also the regions formed between the lifting platforms 11, form the working space.

The receiving device 24 according to the invention is provided on the load receiver 16. The receiving device 24 is made rod-shaped and runs parallel to the lifting column 14. The receiving device 24 can comprise a given length or can be differently adjustable in length, for example by means of a telescopic constitution. The receiving device 24 is preferably spaced apart from the lifting column 14 at an outer edge region of the lifting platform 16. The supply line 23 is thereby prevented from getting jammed in the region between the load receiver 16 and the lifting column 14.

The receiving device 24 is releasably provided by a plug connection 26 to a fastening 27 arranged on the load receiver. The receiving device 24 can thereby be used as desired. Alternatively, it can be provided that the receiving device 24 has a quick fastener unit, so that existing and already delivered lifting platforms can be retrofitted with the receiving device 24 according to the invention.

The receiving device 24 has a height that, for example, is situated in the region of the junction point 21 of the control unit, or somewhat lower. This gives an ergonomic working height, as can be seen from FIG. 3, for example, in order to bring the supply lines 23 to a cable guide 28 which is provided at the upper end of the receiving device 24. The cable guide 28 is embodied in a V-shape, and is for example of round bar steel, which can be constituted with and without a coating. This cable guide 28 is rotatably received in the receiving device 24. Alternatively, the cable guide 28 can be fixed to the receiving device 24, and this can be rotatably mounted in the fastening 27. It is thereby made possible for the cable guide 28 to be aligned in an optional angular position from the lifting platform 11 to the next following lifting platform 11. The cable guide 28 is simultaneously constituted as a clamping device because of the embodiment as a V-shaped fork. Alternatively, it can be provided that, for example, a cable guide 28 is formed by a slide surface or a running roller, and in addition a clamping element or a clip connection or the like is provided, whereby the supply line 23, after being stretched or tightened between two devices 24, is fixed in a simple and rapid manner. The result can thus be attained that the at least one supply line 23 does not sag, or sags only slightly, as is shown in FIGS. 3 and 4, for example.

With an embodiment of a V-shaped fork as the cable guide and clamping element, a further cable guide 29 is advantageously provided below the junction point 21. This can be installed on the receiving device 24, on the fastening 27, or on the load receiver 16. This cable guide 29 maintains the clamping in the embodiment shown in FIG. 1 as long as the junction point 21 is positioned higher than the cable guide 28. In addition, the cable guide 29 has the advantage that the free length of the supply line 23 is guided between the junction point 21 and the cable guide 28.

The receiving device 24 can advantageously be variably adjustable in height. Thereby, for example, the upper cable guide 28 can be set exactly in the position such that this is at least equal to or higher than the ground clearance of the vehicle. The passage region can thus be free, as shown in FIG. 4, even with a slightly sagging supply line 23.

The receiving device 24 can alternatively have an adjustable pivot joint in the lower region above the fastening 27. A deflection of the receiving device 24 can thereby be given, for example when there is an unintentional deflection in the supply line 23, so that the path length is lengthened by the height of the receiving device 24. Instead of a pivot joint, a further unit can likewise be provided on the receiving device 24, and applies a tension to the supply line 23 after the positioning of the lifting platforms and subsequently of the supply line 23, so that the latter does not sag, and in the case of an unintentional deflection, releases a corresponding length of the supply line 23 as a strain relief. It can furthermore alternatively be provided that the upper line guide 28 is releasable from the receiving device 24, so that it is interchangeable with other line guides or likewise releases a further length of supply line in an emergency.

The supply line 23 is attached to the junction point 21 by a plug connection or a screw connection.

Depending on the embodiment of the lifting platform 11, it can also be provided that several supply lines are laid from lifting platform 11 to lifting platform 11. In special cases, the supply line can also be constituted as a hydraulic or pneumatic hose, in order to operate the individual lifting platforms 11.

It can alternatively be provided that a kind of strut is provided on the load receiver 16 and has at least one horizontal connecting rod between the left and right devices 24. A respective junction point, for the supply lines 23 which can be arranged between two lifting platforms 11 to be connected, can be provided on this rod near the devices 24, these junction points being connected to the control unit 19 by a respective fixedly installed line section. The length of the fixedly installed line section required for the lifting path can thus be adapted to each lifting extent of the lifting platform. The handles [sic] required for connecting the mobile lifting platform are further reduced. The supply line 23 is at least slightly tensioned and connected to the two connections of the respective receiving device 24.

Alternatively, it can likewise be provided that instead of two devices 24 on the load receiver 16, only one device is provided, with a cable guide for two or more supply lines.

The receiving device 24 can alternatively provided as movable up and down along the lifting column 14, The receiving device 24 is advantageously moved up and down by means of an actuating element provided on the load receiving element, or a slider, corresponding to the lifting movement of the load receiver. The arrangement of the receiving device 24 can be such that only the upward movement is driven, and the downward movement takes place by gravity; or that both directions of movement are driven. The device arranged on the lifting column can be constituted as a telescoping rod, and the slider actuates the telescopic rod. Alternatively, a guide, in which at least the cable guide 28 is moved up and down, can also be provided on the lifting column.

It can also be provided that a receiving device 24 is provided on the lifting plunger itself, in order to receive the supply line according to the invention. The receiving device 24 can for example be provided to run horizontally, so that the cable guide 28 is advantageously provided near to a left-hand and right-hand outer end and aligned above the respective corner region of the load receiver.

Furthermore, the receiving device 24 can be provided in the transition region between the lifting plunger and the wheel gripper, and can extend vertically upward, in order to make possible a cable guide 28 for a two-sided connection, as for example of the lifting platforms 11a-11f according to FIG. 6. It can furthermore be provided that from this one fastening point in the region respectively at least two cable guides are arranged left and right in or near the corner regions of the load receiver and elevated with respect to these corner regions, in order to at least above the ground clearance of the vehicle.

Good accessibility in the working region of several lifting platforms 11 is given, as apparent from FIG. 4, by means of the arrangement according to the invention of the at supply line 23 on a receiving device 24 installed on the load receiver 16.

I claim:

1. A lifting platform, having a working region, for lifting loads, vehicles, or the like, comprising a base frame,
a load receiver,
a lifting unit that moves the load receiver up and down,
at least one supply line that is provided between at least two lifting platforms,
at least one receiving device can be installed,
that receives the at least one supply line, and positions the at least one supply line outside the working region of the lifting platform.

2. The lifting platform according to claim 1, wherein the receiving device is installed on the load receiver.

3. The lifting platform according to claim 1, wherein the receiving device is rod-shaped and comprises an upper end having a cable guide.

4. The lifting platform according to claim 3, wherein the cable guide comprises a clamping device.

5. The lifting platform according to claim 3, comprising a releasable plug connection in an upper region of the receiving device for receiving the cable guide.

6. The lifting platform according to claim 3, wherein the cable guide is arranged for receiving the at least one supply line.

7. The lifting platform according to claim 4, wherein the cable guide comprises a V-shaped fork and the at least one supply line is fixed automatically by its own weight in the clamping device.

8. The lifting platform according to claim 1, comprising a lower cable guide on the load receiver or on the receiving device below a junction point, in a region of the load receiver.

9. The lifting platform according to claim 8, wherein the distance between the junction point and the lower cable guide in an inoperative position of the load receiver is equal to or greater than the distance between the junction point and the lower cable guide in a working position of the load receiver.

10. The lifting platform according to claim 1, wherein the distance between the line guide and the load receiver is at least equal to or greater than the ground clearance of a vehicle.

11. The lifting platform according to claim 1, wherein the cable guide is arranged to rotate with respect to the receiving device or the receiving device is arranged to rotate with respect to the load receiver.

12. The lifting platform according to claim 1, comprising at least one junction point for the at least one supply line arranged substantially at half a height of a maximum lifting path.

13. The lifting platform according to claim 1, wherein the receiving device is variable in height and is constituted in telescopic form.

14. The lifting platform according to claim 1, wherein the receiving device is at least slightly deflectable and receives the at least one supply line between two lifting platforms under at least slight tension.

15. The lifting platform according to claim 1, wherein the receiving device is releasably fastened to the load receiver.

16. The lifting platform according to claim 1, wherein the receiving device comprises a pivot joint in a lower region near a fastening unit of the load receiver.

17. The lifting platform according to claim 1, comprising an appliance on the receiving device for strain relief and for tightening of the at least one supply line.

18. The lifting platform according to claim 1, wherein the load receiver comprises a wheel gripper for motor vehicles.

19. The lifting platform according to claim 1, wherein the base frame comprises a traveling means, in particular a steer-able traveling means.

20. The lifting platform according to claim 1, wherein the lifting unit comprises an electro-hydraulic, hydraulic, or mechanical drive.
